(19) United States
(12) Patent Application Publication
(10) Pub. No.: US 2009/0147784 A1
(43) Pub. Date: Jun. 11, 2009

(54) Field network system

(75) Inventor: Kazunori Miyazawa, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 12/316,081

(22) Filed: Dec. 9, 2008

(30) Foreign Application Priority Data
Dec. 10, 2007 (JP) 2007-318605

(51) Int. Cl. H04L 12/56

(52) U.S. Cl. 370/390; 370/400

(57) ABSTRACT

A field network system is provided. The field network system includes a plurality of field devices and a plurality of tunneling units. The field devices are coupled to each other through an IP network. The IP network is divided into a plurality of subnetworks. Each of the tunneling units is provided in each of the subnetworks to conduct tunneling communication.

This application claims priority from Japanese Patent Application No. 2007-318605, filed on Dec. 10, 2007, the entire contents of which are hereby incorporated by reference.

### BACKGROUND OF THE INVENTION

1. Technical Field

The present disclosure relates to a field network system using an Internet Protocol (IP) network and more particularly to control of multicast communication.

2. Related Art

In recent years, it has been proposed that field devices including a controller, an actuator or a sensor such as a thermometer or a flowmeter constituting a feedback control loop are connected by a network and are built as a field network system in a process control system in industrial automation.

These field devices transmit and receive various information such as measurement information or control information using a predetermined control network protocol, and perform control processing so as to optimally operate a controlled object of a plant etc.

For example, Japanese Patent Application Publication JP-A-2003-242123 describes a field network system in the related art.

FIG. 6 is a configuration block diagram of the related-art field network. Field devices 1 to 12 are installed in a plant, and have a communication function of transmitting data or a function of executing a functional block unique to of the field devices of analog signal input (AI), analog signal input and output (AO), PID computation (proportional, integral, derivative computation), etc.

Routers 13 to 16 have a transfer function of selecting a transfer destination and transferring a received packet. A network NW100 has a wide band at which the backbone is constructed. In addition, the routers 13 to 16 may be a layer 3 (L3) switch.

A configurator 17 has a setting function of setting various actions or an action schedule of the field devices 1 to 12 and a communication function of transmitting the setting information. A controller 18 has a communication function of transmitting data and an operation control function of operating so that a measured value received from a sensor converges on a predetermined target value.

The field devices 1 to 4 are connected to the network NW100 through the router 13 and the field devices 5 to 8 are connected to the network NW100 through the router 14 and the field devices 9 to 12 are connected to the network NW100 through the router 15 and further, the configurator 17 and the controller 18 are connected to the network NW100 through the router 16.

Such a field network is built as, for example, a field bus FF-HSE (registered trademark).

FIGS. 7 and 8 are explanatory diagrams to describe an action of the field network system shown in FIG. 6. Each of the field devices 1 to 12 notifies the configurator 17 of advertisement for device information about itself or finding of a new device, etc.

At this time, each of the field devices 1 to 12 uses a multicast address. The multicast address is a well-known destination that all the units connected to a field network can use. In addition, all the units participating in the field network participate in this multicast group.

For example, as shown in FIG. 7, the field device 1 sends a “device information advertisement packet” for notifying the configurator 17 of device information such as setting information or identification information about each of the field devices constituting the field network, to a predetermined multicast address destination.

The router 13 receives the device information advertisement packet from the field device 1, and copies this device information advertisement packet, and then transfers the packet to the field devices 2 to 4 and the routers 14 to 16, respectively.

At this time, the router 13 performs transfer processing based on a network address, so that an implicit destination (e.g., a configurator) in a control network protocol stored in a payload etc. of a packet cannot be identified.

Then, the router 14 copies the received device information advertisement packet and transfers the packet to the field devices 5 to 8, and the router 15 copies the received device information advertisement packet and transfers the packet to the field devices 9 to 12, and the router 16 copies the received device information advertisement packet and transfers the packet to the configurator 17 and the controller 18.

Thus, the field device 1 notifies advertisement for device information about itself or finding of a new device, etc. using a multicast packet.

By the way, in the field network in which the IP is performed, for example, a link used in an explosion-proof area, a power-saving wireless link, etc. are used or a link with a band narrower than 100 Mbps or 1 Gbps may also be included. Then, in the field device, a unit with a low throughput may be used since power consumption is limited.

However, in the routers 13 to 16 or a router (not-shown), transfer processing is performed based on a network address, so that an implicit destination of a control network protocol in a device information advertisement packet cannot be identified and a multicast packet is transferred to all the units as shown in FIG. 8.

Consequently, in a network to which a narrowband link, a power-saving wireless link or a field device with a low throughput is connected, there are problems in that the narrowband link is pressed and a load of the field device increases and packet transmission delays.

Also, in a network with a wide band constituting the backbone of the field network, a packet to be sent is close to substantially broadcast. Thus, this leads to an unnecessary load.

### SUMMARY OF THE INVENTION

Exemplary embodiments of the present invention address the above disadvantages and other disadvantages not described above. However, the present invention is not required to overcome the disadvantages described above, and thus, an exemplary embodiment of the present invention may not overcome any of the problems described above.

Accordingly, it is an aspect of the present invention to reduce a load of a narrowband link, a field network and a field device.

According to one or more aspects of the present invention, a field network system is provided. The field network system includes a plurality of field devices and a plurality of tunneling units. The field devices are coupled to each other through an IP network. The IP network is divided into a plurality of subnetworks. Each of the tunneling units is provided in each of the subnetworks to conduct tunneling communication.

According to one or more aspects of the present invention, only when a destination in a control network protocol of a multicast packet is present in each device information about a field device connected to another tunneling unit, each of the tunneling units permits tunneling communication with said another tunneling unit connected to the destination.

According to one or more aspects of the present invention, each of the tunneling units performs encapsulation based on a multicast packet received from each of the field devices to generate a tunnel packet, and each of the tunneling units performs decapsulation based on the tunnel packet to reproduce the multicast packet and then transfers the multicast packet to a destination in a control network protocol.

According to one or more aspects of the present invention, each of the tunneling units comprises: a communication section for conducting packet communication; a storage section for storing at least one of first device information about a field device connected to the tunneling unit, unit information about another tunneling unit and second device information about another field device connected to said another tunneling unit; and a computation control section being operable to: i) analyze a multicast packet; ii) extract a destination in a control network protocol; iii) permit transfer only when the destination is present in the second device information; iv) generate a tunnel packet; and v) send the tunnel packet to said another tunneling unit connected to the destination in the control network protocol.

According to one or more aspects of the present invention, the computation control section is further operable to: vi) perform decapsulation on the tunnel packet received from said another tunneling unit to reproduce the multicast packet; and vii) transfer the multicast packet to the destination in the control network protocol.

According to one or more aspects of the present invention, the computation control section is further operable to: viii) analyze a packet received from each of the field devices to store the second device information in the storage section.

Other aspects and advantages of the invention will be apparent from the following description, the drawings and the claims.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a configuration block diagram showing a field network system according to an exemplary embodiment of the present invention;

FIG. 2 is a configuration block diagram of a tunneling unit 39 shown in FIG. 1;

FIG. 3 is a flowchart of the field network system according to the exemplary embodiment of the present invention;

FIG. 4 is an explanatory diagram to describe an action of the field network system according to the exemplary embodiment of the present invention;

FIG. 5 is an explanatory diagram to describe an action of the field network system according to the exemplary embodiment of the present invention;

FIG. 6 is a configuration block diagram of the related-art field network system;

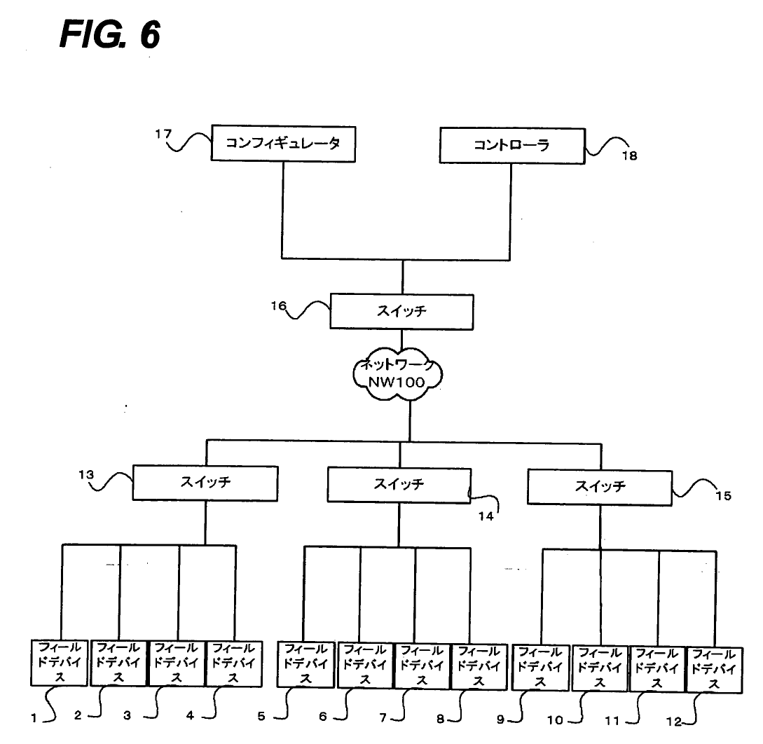

FIG. 7 is an explanatory diagram to describe an action of the field network system shown in FIG. 6; and

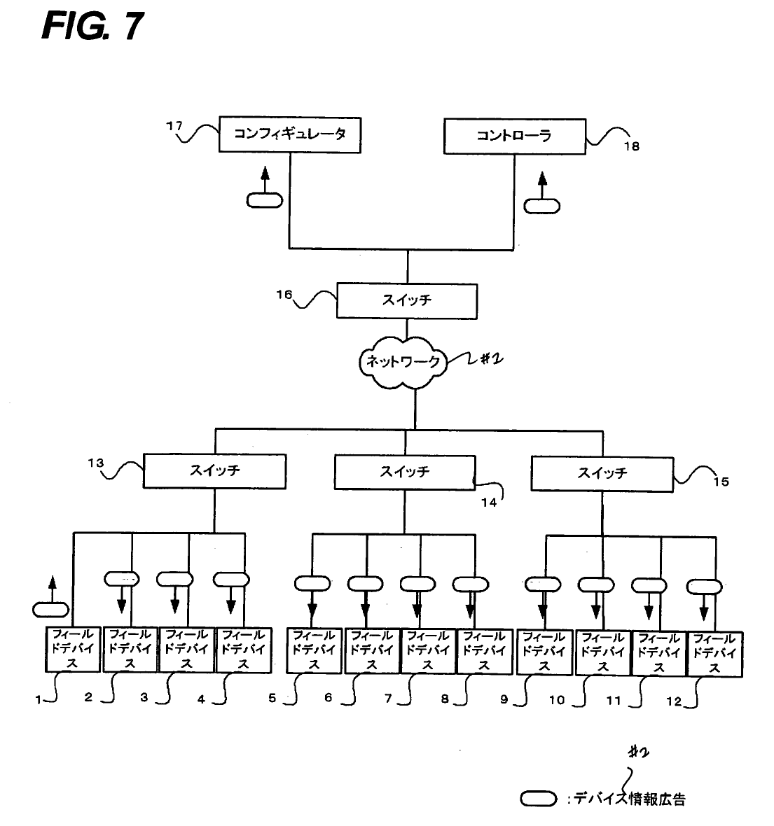

FIG. 8 is an explanatory diagram to describe an action of the field network system shown in FIG. 6.

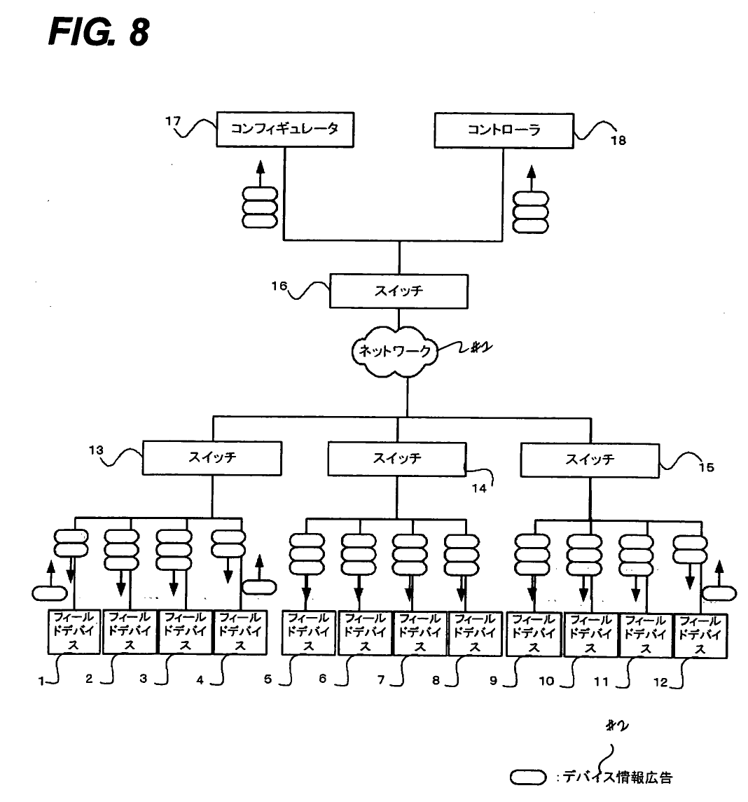

### DETAILED DESCRIPTION OF EXEMPLARY EMBODIMENTS OF THE INVENTION

Exemplary embodiments of the present invention will be described with reference to the drawings hereinafter.

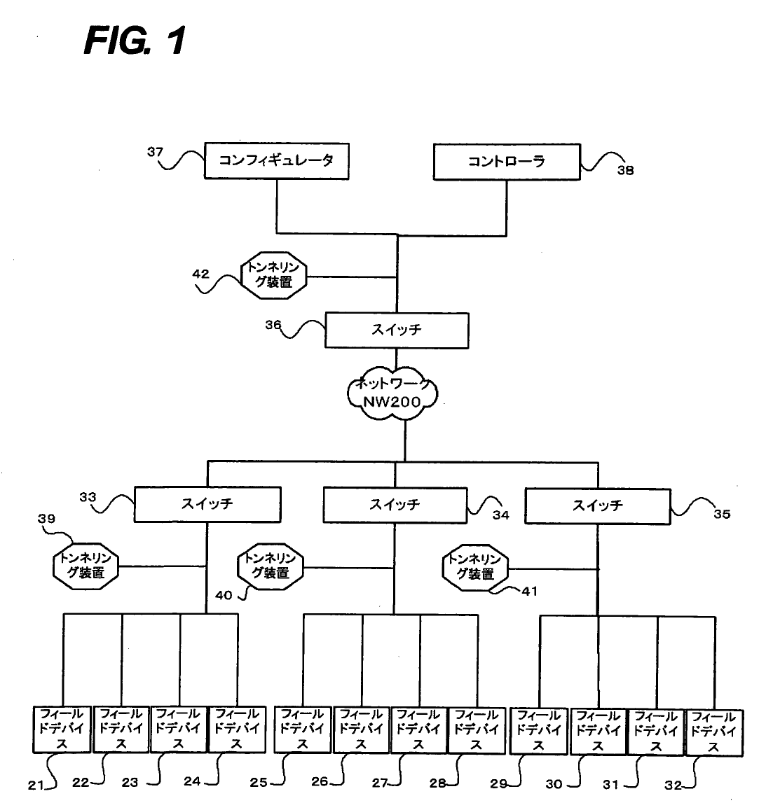

FIG. 1 is a configuration block diagram showing a field network system according to an exemplary embodiment of the present invention. A configuration of the field network system is substantially similar to the related-art configuration, and field devices 21 to 32 are installed in a plant and are built as, for example, a field bus FF-HSE (registered trademark), and the whole network is constructed by plural subnetworks of small networks using routers 33 to 36. Tunneling units 39 to 42 are provided in each of the subnetworks. A network NW200 has a wide band constructing the backbone. In addition, the routers 33 to 36 may be a layer 3 (L3) switch.

The field devices 21 to 24 are connected to the network NW200 through the router 33 and the tunneling unit 39, and the field devices 25 to 28 are connected to the network NW200 through the router 34 and the tunneling unit 40, and the field devices 29 to 32 are connected to the network NW200 through the router 35 and the tunneling unit 41, and a configurator 37 and a controller 38 are connected to the network NW200 through the router 36 and the tunneling unit 42.

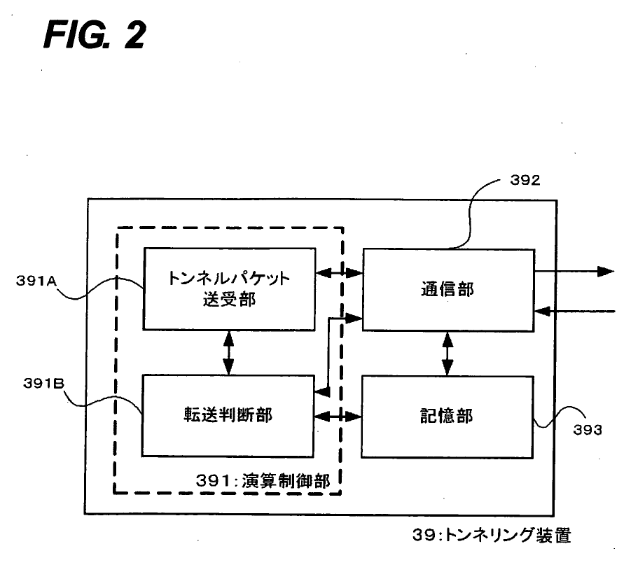

All the tunneling units 39 to 42 have a similar configuration and the tunneling unit 39 will be described with a configuration block diagram shown in FIG. 2 as a typical example. The tunneling unit 39 is constructed of a computation control section 391, a communication section 392 and a storage section 393, and the computation control section 391 is constructed of a tunnel packet sending and receiving section 391A and a transfer decision section 391B. The communication section 392 is connected to the computation control section 391, and the computation control section 391 is connected to the storage section 393.

The communication section 392 communicates with the field devices 21 to 24 and the router 33 mainly. The computation control section 391 is configured to control an action of each section and, for example, a Central Processing Unit (CPU) is used. An Operating System (OS), a program for operating as the tunneling unit, various information such as tag information or identification information about each of the field devices are stored in the storage section 393.

The tunnel packet sending and receiving section 391A receives a packet from the field devices 21 to 24 mainly, and performs encapsulation processing for adding various extension headers or an IP header including a network address of another tunneling unit to the received packet, and then generates and sends a tunnel packet. Also, the tunnel packet sending and receiving section 391A performs decapsulation processing based on the tunnel packet received from another tunneling unit, and reproduces and analyzes the packet before encapsulation and grasps packet information such as a sending destination and a sending source.

The transfer decision section 391B decides whether or not a multicast packet received from the field devices 21 to 24 or a tunnel packet received from another tunneling unit can be transferred to each unit connected to the subnetwork.

Also, the computation control section 391 analyzes an advertisement packet including unit information such as a device ID received from another unit or the field devices 21 to 24, and extracts the unit information and stores the unit information in the storage section 393.

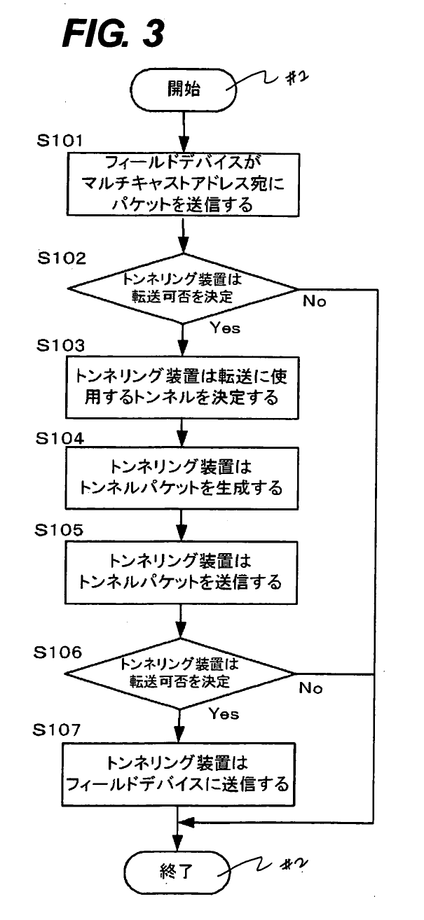

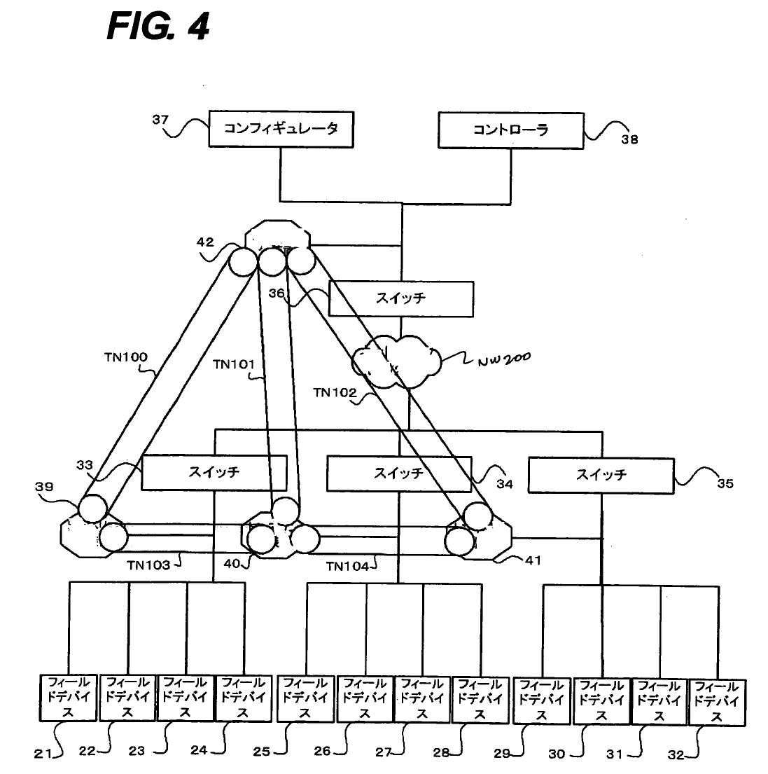

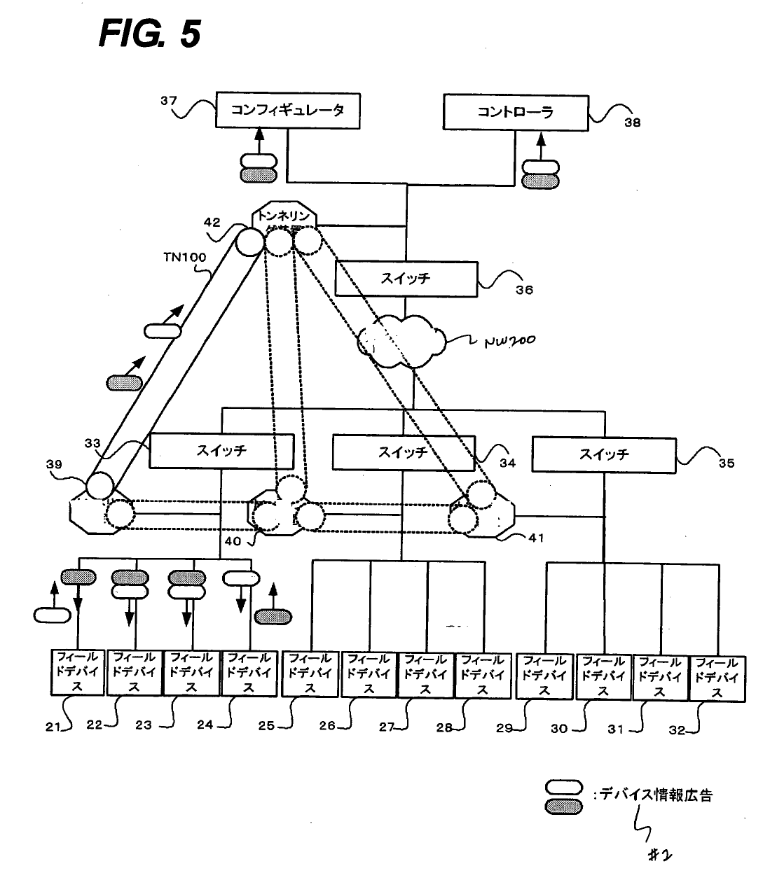

FIG. 3 is a flowchart of the field network system, and FIGS. 4 and 5 are explanatory diagrams to describe an action of the field network system. An action in which the field device 21 advertises device information about itself to the configurator 37 will be described hereinafter.

It is assumed that the tunneling units 39 to 42 mutually grasp each of the network addresses and tunneling communication (see e.g., tunnels TN100 to TN104 in FIG. 4) is built between each of the tunneling units. Also, it is assumed that the tunneling units 39 and 42 participate in a “multicast group” in which the same multicast address (for example, a multicast address 224.0.0.33) is received in advance.

The tunneling units 39 to 42 previously store “device information” such as a tag name or a network address of a configurator or a field device connected to each link, “unit information” such as a tag name or a network address of other tunneling units, and device information about a device connected to other tunneling units.

In step S101 of FIG. 3, the field device 21 sends a “device information advertisement packet” for notifying device information to a destination of a predetermined multicast address (for example, 224.0.0.33) as shown in FIG. 5. In addition, the device information advertisement packet is received by the tunneling unit 39 and the field devices 22 to 24 belonging to the same subnetwork as shown in FIG. 5.

In step S102, the computation control section 391 of the tunneling unit 39 starts a task stored in the storage section 393, and the transfer decision section 391B determines whether or not transfer can be performed based on the device information advertisement packet received from the field device 21.

Concretely, the tunnel packet sending and receiving section 391A of the tunneling unit 39 analyzes the device information advertisement packet, and extracts a network address or a tag name of a destination (for example, the configurator 37) of a control network protocol stored in a payload etc.

Then, the transfer decision section 391B determines that transfer is permitted when the destination of the control network protocol extracted from the device information advertisement packet is present in these device information based on the device information about each device connected to each tunneling unit stored in the storage section 393, and then the process goes to step S103. It is determined that transfer is not permitted when the destination of the control network protocol is not present in these device information, and the process is ended.

In addition, an action in which the computation control section 391 of the tunneling unit 39 reads out and executes a program stored in the storage section 393 and controls each section is similar to those of the other tunneling units, an thus the description is hereinafter omitted.

In step S103, the transfer decision section 391B of the tunneling unit 39 grasps the tunneling unit (for example, the tunneling unit 42) to which the destination (for example, the configurator 37) of the control network protocol is connected based on the device information stored in the storage section 393, and determines the tunneling unit as a communication destination of tunneling communication. In other words, the tunneling unit 39 determines a tunnel (for example, a tunnel TN100 of FIG. 5) used in transfer.

In step S104, the tunnel packet sending and receiving section 391A of the tunneling unit 39 performs encapsulation processing in the device information advertisement packet and generates a tunnel packet.

Concretely, the tunnel packet sending and receiving section 391A generates the tunnel packet by adding an IP header including a network address of the tunneling unit 42 to the device information advertisement packet based on unit information about the tunneling unit (e.g., the tunneling unit 42) determined as the communication destination of tunneling communication.

In step S105, the tunnel packet sending and receiving section 391A of the tunneling unit 39 sends a tunnel packet of a destination of the tunneling unit 42 to the router 33. In addition, this tunnel packet is transferred to the tunneling unit 42 through the router 33, the network NW200 and the router 36 as shown in FIG. 5.

In step S106, the transfer decision section 391B of the tunneling unit 39 determines whether or not transfer can be performed based on the device information advertisement packet received from the field device 21.

Concretely, a tunnel packet sending and receiving section of the tunneling unit 42 performs decapsulation processing on the tunnel packet received from the router 36 and reproduces the device information advertisement packet before encapsulation, and analyzes this packet and grasps a network address or a tag name of a destination (e.g., the configurator 37) of a control network protocol stored in a payload etc.

Then, a transfer decision section of the tunneling unit 42 determines that transfer is permitted when the destination (configurator 37) of the control network protocol extracted from the device information advertisement packet is present in these device information based on the device information about each device connected to the tunneling unit 42 stored in a storage section, and then the process goes to step S107. It is determined that transfer is not permitted when the destination (configurator 37) of the control network protocol is not present in these device information, and the process is ended.

In step S107, the tunnel packet sending and receiving section of the tunneling unit 42 sends the device information advertisement packet to a link including the configurator 37.

The action of steps S101 to S107 by these tunneling units and field devices is substantially the same action even when any field device sends the device information advertisement packet. When the field device 24 sends the device information advertisement packet, the packet is transferred to the field devices 21 to 23 belonging to the same subnetwork, the tunneling units 39 and 42, the configurator 37 or the controller 38 as shown in FIG. 5.

Thus, only when a destination in a control network protocol of a multicast packet received from each field device is present in each device information of another tunneling unit grasped in advance, each of the tunneling units selects a tunneling unit connected to this destination and conducts tunneling communication and thereby, a load of a narrowband link, a field network and the field device can be reduced.

Also, unnecessary communication of the multicast packet is eliminated so that a load on a network with a wide band constructing the backbone of a control network can also be reduced.

In addition, a router or a relay unit such as the router may have a function of each of the tunneling units shown in the above-described exemplary embodiment.

Also, in the above-described exemplary embodiment, a path may be made redundant by building plural tunnels. The plural tunnels are provided such that the multicast packet is routed through another path between the tunneling units. As a result of this, communication can be conducted through another path even when any path cannot communicate due to a communication failure etc.

Also, according to the above-described exemplary embodiment, the tunneling unit determines whether to transfer based on the device information advertisement packet, but the tunneling unit may determine whether to transfer based on a multicast packet used in a control network protocol.

Also, in the above-described exemplary embodiment, a security function may be provided for tunneling communication by using an Secure Sockets Layer (SSL) tunnel or a tunnel mode of IPsec (Security Architecture for Internet Protocol).

Also, in the above-described exemplary embodiment, the tunneling units are installed in each subnetwork one-by-one, but may be installed every narrowband link between the router and each of the field devices. As a result of this, when the tunneling units are installed in each subnetwork one-by-one, a multicast packet sent and received inside the subnetwork cannot be controlled. Accordingly, by installing the tunneling units every the narrowband link between the router and each of the field devices, sending and receiving of the multicast packet can be controlled inside the subnetwork so that unnecessary communication of the multicast packet can be eliminated.

Also, in the above-described exemplary embodiment, the tunneling unit determines whether to transfer a device information advertisement packet based on device information about each device connected to another tunneling unit, but information about a control network protocol stored in a payload of the received device information advertisement packet may be grasped and device information about a configurator, a controller or a field device of a subnetwork in which the tunneling unit is installed may be stored. That is, the tunneling unit may learn each device information about the subnetwork, based on the received device information advertisement packet.

For example, the tunneling unit learns each unit information about the subnetwork, based on the received device information advertisement packet. Thus, a transfer destination of a multicast packet can be grasped. As a result of this, the tunneling unit can determine whether to transfer the multicast packet to the subnetwork belonging to the tunneling unit, in the case of searching a field device or in the case of finding a field device in a field network using the information obtained by learning.

Also, in the above-described exemplary embodiment, although there has been described the case that the field network system supports an operation of a plant in industrial automation, exemplary embodiments are not limited thereto. For example, the field network system may support an operation of a controlled object in an air conditioning and illumination system of a building or a control system of a water purification plant in factory automation.

By also applying the present invention to such systems, each of the tunneling units analyzes a multicast packet received from each of the field devices and grasps a destination of a control network protocol and transfers the multicast packet to only a subnetwork connected to this destination by tunneling communication. Therefore, a load of a narrowband link, a field network and the field device can be reduced.

In addition, in the above-described exemplary embodiment, the computation control section 391 of the tunneling unit 39 may control the whole tunneling unit 39 by starting an OS stored in the storage section 393 and reading out and executing a program stored on the OS.

Also, in the above-described exemplary embodiment, a tunneling unit receives a device information advertisement packet from a field device. Then, a field device in a subnetwork in which the tunneling unit is installed is recognized and then the tunneling unit communicates with the field device using a control network protocol. Then, information about multicast communication (unknown multicast communication is included in the tunneling unit) used by the field device is acquired and stored and thereby, learning may be made.

In this case, the tunneling unit can grasp the initially-unknown multicast communication between field devices and also control is performed so that the tunneling unit can receive the multicast communication grasped in a router or a switch, etc. Thus, sending and receiving between the field devices which conduct the initially-unknown multicast communication and which are connected to a field network system can be controlled and unnecessary communication of a multicast packet is eliminated.

While the present invention has been shown and described with reference to certain exemplary embodiments thereof, other implementations are within the scope of the claims. It will be understood by those skilled in the art that various changes in form and details may be made therein without departing from the spirit and scope of the invention as defined by the appended claims.

What is claimed is:

1. A field network system comprising:
a plurality of field devices coupled to each other through an IP network, wherein the IP network is divided into a plurality of subnetworks; and
a plurality of tunneling units each provided in each of the subnetworks to conduct tunneling communication.

2. The field network system as claimed in claim 1, wherein only when a destination in a control network protocol of a multicast packet is present in each device information about a field device connected to another tunneling unit, each of the tunneling units permits tunneling communication with said another tunneling unit connected to the destination.

3. The field network system as claimed in claim 1, wherein each of the tunneling units performs encapsulation based on a multicast packet received from each of the field devices to generate a tunnel packet, and
wherein each of the tunneling units performs decapsulation based on the tunnel packet to reproduce the multicast packet and then transfers the multicast packet to a destination in a control network protocol.

4. The field network system as in claim 1, wherein each of the tunneling units comprises:
a communication section for conducting packet communication;
a storage section for storing at least one of first device information about a field device connected to the tunneling unit, unit information about another tunneling unit and second device information about another field device connected to said another tunneling unit; and
a computation control section being operable to:
i) analyze a multicast packet;
ii) extract a destination in a control network protocol;
iii) permit transfer only when the destination is present in the second device information;
iv) generate a tunnel packet; and
v) send the tunnel packet to said another tunneling unit connected to the destination in the control network protocol.

5. The field network system as in claim 4, wherein
the computation control section is further operable to:
vi) perform decapsulation on the tunnel packet received from said another tunneling unit to reproduce the multicast packet; and
vii) transfer the multicast packet to the destination in the control network protocol.

6. The field network system as claimed in claim 5, wherein
the computation control section is further operable to:
viii) analyze a packet received from each of the field devices to store the second device information in the storage section.
